(19) United States
(12) Patent Application Publication
(10) Pub. No.: US 2005/0078221 A1
(43) Pub. Date: Apr. 14, 2005

(54) Apparatus for generating video contents with balloon captions, apparatus for transmitting the same, apparatus for playing back the same, system for providing the same, and data structure and recording medium used therein

(76) Inventor: Koji Kobayashi, Kadoma (JP)

Correspondence Address: WENDEROTH, LIND & PONACK, L.L.P., 2033 K STREET N. W., SUITE 800, WASHINGTON, DC, 20006-1021, US

(21) Appl. No.: 10/946,005

(22) Filed: Sep. 22, 2004

(30) Foreign Application Priority Data
Sep. 26, 2003 (JP) 2003-336198

(51) Int. Cl. H04N 9/76

(52) U.S. Cl. 348/600; 348/598

(57) ABSTRACT

A contents generating apparatus generates balloon data required for providing video contents with balloon captions. Balloon data includes at least one piece of information among information about time to display a balloon, information about an area where the balloon is to be displayed, information about a shape of the balloon, and information about caption text to be inserted in the balloon. A contents transmitting apparatus multiplexes balloon data and contents data, and causes a broadcast apparatus to broadcast the multiplexed data. A contents playback apparatus analyzes the balloon data to generate a signal for a balloon image and a signal for caption text, combines these signals with a signal for a video image, and then causes a contents display apparatus to display the video with balloon captions.

### BACKGROUND OF THE INVENTION

1. Field of the Invention

The present invention relates to video-contents generating apparatuses, video-contents transmitting apparatuses, video-contents playback apparatuses, video-contents providing systems, and data structures and recording media used therein. More specifically, the present invention relates to an apparatus for generating video contents with captions, an apparatus for transmitting such video contents, an apparatus for playing back such video contents, a system for providing such video contents, and a data structure and a recording medium used in these apparatuses.

2. Description of the Background Art

Conventionally, in order to help understanding the contents of a foreign-language movie, a dialogue among characters in the movie is translated into a viewers' native language and the translation is displayed with text in their native language on an inner edge of the screen. With this, the viewers can fully understand the dialog even the characters are speaking foreign language. In recent years, as an example of a directorial technique in television broadcasting, even when characters speak the viewers' native language, text of the dialog among the characters is displayed on an inner edge of the screen. Furthermore, text other than that of characters' dialogs may be displayed on an inner edge of the screen in order to describe the scene. Each such text displayed on an inner edge of the screen is referred to as a caption. Such a caption being displayed on the video can help the viewers understand the dialog among the characters in the video and also understand the contents of the video.

In recent years, for the purpose of easy understanding of a relation between a speaker and a caption on the screen, various schemes have been suggested. For example, captions for female speakers are colored in warm color, while captions for male speakers are colored in cold color. In another example, each caption is provided with a name of the speaker.

Instill another example, in order to enhance the visual understanding of a relation between a speaker and a caption on the screen, the caption is provided at the speaker's mouth (refer to Japanese National Phase PCT Laid-Open Publication No. 9-505671). An apparatus disclosed in this gazette three-dimensionally calculates a position of the speaker on the screen, a position of the speaker's mouth, and an orientation of the speaker's body. Furthermore, the apparatus three-dimensionally calculates a direction toward which the speaker on the screen makes a speech. The apparatus renders the direction of speech on a two-dimensional plane as a reference line, on which speech text is displayed.

In general, even with captions, the viewer causes the sound of speech to be produced, and then, with reference to the feature of the sound of speech, such as whether the pitch is high or low, the viewer recognizes who is the speaker. Therefore, when using conventional captions completely without the sound of speech, the viewer would not ascertain who is speaking on the screen. This is particularly a problem when a plurality of speakers are simultaneously present on the screen.

Moreover, it may be possible to indicate who is speaking by changing the color of the text, as in the conventional technique. However, this technique merely gives the viewer a hint as to who is speaking. Without the sound of speech, the viewer may not be able to clearly ascertain who is speaking.

Still further, it may be possible to indicate who is speaking by displaying the name of the speaker. However, this technique has some great disadvantages, such as an increase in the number of caption letters.

Still further, the scheme as disclosed in the above gazette of displaying a caption from the speaker's mouth along the reference line also has some problems. For example, the face of a character other than that of the speaker or an important scene may be hidden by the caption text.

As such, in the conventional video displaying schemes using captions, understanding the relation between the speaker and the caption is not easy. Moreover, even if the relation between the speaker and the caption is clear, the viewer often feels uncomfortable when viewing the entire screen.

### SUMMARY OF THE INVENTION

Therefore, an object of the present invention is to provide a video-contents generating apparatus, a video-contents transmitting apparatus, a video-contents playback apparatus, a video-contents providing system, and a data structure and a recording medium used therein that allow easy understanding of a relation between a speaker and a caption and easy viewing of the entire screen.

A further aspect of the present invention to provide a video-contents generating apparatus, a video-contents transmitting apparatus, a video-contents playback apparatus, a video-contents providing system, and a data structure and a recording medium used therein that allow easy understanding of a relation between a speaker and a caption even without the sound of speech and easy viewing of the entire screen.

In order to attain the above objects, the present invention has the following features. The present invention is directed to a contents generating apparatus for generating data required for providing video contents with balloon captions. The contents generating apparatus includes balloon-display-time extracting means, balloon-area determining means, balloon-image determining means, caption-text determining means, and balloon data generating means. The balloon-display-time extracting means extracts time to display the balloon in video based on video-contents-data serving as original data. The balloon-area determining means determines a balloon are a suitable for displaying the balloon in video at the time extracted by the balloon-display-time extracting means. The balloon-image determining means determines a balloon image to be combined with the balloon area determined by the balloon-area determining means. The caption-text determining means determines caption text to be combined with the balloon image determined by the balloon image determining means. The balloon-data generating means generates balloon data by using at least one piece of information among information about the time to display the balloon, information about the balloon area, information about the balloon image, and information about the caption text. The balloon data generated by the balloon-data generating means is played back together with the video-contents-data, thereby providing the video contents with balloon captions.

Preferably, the balloon-area determining means detects a change in color tone in the video based on the video content data, extracts a flat portion in a flat color tone, and takes a frame included in the flat portion as the balloon area. The balloon-image determining means takes an image allowing the caption text to be displayed in the frame as the balloon image.

More preferably, the balloon-area determining means determines the balloon area by changing the extracted frame based on an instruction from a user. Also, the balloon-image determining means changes the shape of the balloon image based on an instruction from a user. Furthermore, the caption-text determining means determines the caption text based on an instruction from a user.

Also, the caption-text determining means may determine whether the number of caption letters of the caption text per unit time during the time to display the balloon is equal to or more than a predetermined number, and, when the number of caption letters is equal to or more than the predetermined number, notifies the user that the caption text should be changed.

Preferably, the caption-text determining means determines the attribute of the caption text based on an instruction from a user.

Furthermore, the contents generating apparatus may further include multiplex means which multiplexes the video-contents-data and the balloon data generated by the balloon-data generating means. Still further, the contents generating apparatus may further include multiplexed-data transmitting means which transmits data obtained through multiplexing by the multiplex means through a network. Still further, the contents generating apparatus may further include packaged-medium storing means which stores data obtained through multiplexing by the multiplex means in a packaged-medium.

Furthermore, the contents generating apparatus may further include sound-volume determining means which determines a volume of sound during playback of the video-contents-data. At this time, the caption-text determining means may change the attribute of the caption text in accordance with the volume of sound determined by the sound-volume determining means.

Furthermore, the contents generating apparatus may further include face-size extracting means which extracts a size of a face of a person in video based on the video-contents-data. At this time, the balloon-image determining means may determine a start point of the balloon image in accordance with the size of the face extracted by the face-size extracting means.

Preferably, the video-contents-data is encoded through MPEG (Moving Picture Experts Group), and the balloon data is described in XML (extensible Markup Language).

Also, the present invention is also directed to a contents transmitting apparatus for transmitting data required for providing video contents with balloon captions. The contents transmitting apparatus includes balloon-data obtaining means, video-contents-data obtaining means, multiplex means, and transmitting means. The balloon-data obtaining means obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon. The video-contents-data obtaining means obtains the video-contents-data. The multiplex means multiplexes the balloon data obtained by the balloon data and the video-contents-data obtained by the video-contents-data obtaining means. The transmitting means transmits data obtained through multiplexing by the multiplex means.

For example, the transmitting means may transmit the multiplexed data to a broadcast apparatus for wireless broadcasting, or to a contents playback apparatus for playing back the video-contents-data and the balloon data.

The present invention is also directed to a contents-stored packaged-medium generating apparatus for creating a packaged medium having stored therein data required for video contents with balloon captions. The contents-stored packaged-medium generating apparatus includes balloon-data obtaining means, video-contents-data obtaining means, multiplex means, and storage means. The balloon-data obtaining means obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon. The video-contents-data obtaining means obtains the video-contents-data. The multiplex means multiplexes the balloon data obtained by the balloon data and the video-contents-data obtained by the video-contents-data obtaining means. The storing means stores data obtained through multiplexing by the multiplex means in a packaged medium.

The present invention is also directed to a contents playback apparatus for playing back video contents with balloon captions. The contents playback apparatus includes balloon-data obtaining means, video-contents-data obtaining means, balloon-signal generating means, caption-text signal generating means, video-signal generating means, and combining and transferring means. The balloon-data obtaining means obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon. The video-contents-data obtaining means obtains the video-contents-data. The balloon-signal generating means generates a signal regarding a balloon image based on the balloon data. The caption-text signal generating means generates a signal regarding the caption text based on the balloon data. The video-signal generating means generates a signal regarding video based on the video-contents-data. The combining and transferring means combines the balloon signal generated by the balloon-signal generating means, the caption-text signal generated by the caption-text signal generating means, and the video signal generated by the video-signal generating means to generate a combined signal, and then transfers the combined signal to a display device.

Furthermore, the contents playback apparatus may further include combining/not-combining instructing means which instructs the combining and transferring means to combine or not to combine the balloon signal and the caption-text signal with the video signal. At this time, upon reception of an instruction from the combining/not-combining instruction means for combining the balloon signal and the caption-text signal with the video signal, the combining and transferring means may transfer the combined signal to the display apparatus, and upon reception of an instruction for not combining the balloon signal, the caption-text signal, and the video signal, the combining and transferring means may transfer only the video signal to the display apparatus.

Furthermore, the contents playback apparatus may further include sound-volume measuring means which measures a volume of surrounding sound; and sound-volume-threshold determining means which determines whether the volume of the surrounding sound measured by the sound-volume measuring means exceeds a threshold. At this time, the combining/not-combining instructing means may instruct the combining and transferring means to combine or not to combine the balloon signal and the caption-text signal with the video signal based on the determination results of the sound-volume-threshold determining means.

Preferably, when the sound-volume-threshold determining means determines that the volume of the surrounding sound does not exceed the threshold, the combining/not-combining instructing means instructs the combining and transferring means to combine the balloon signal and the caption-text signal with the video signal, and further prevents an audio output apparatus for outputting audio from outputting audio.

When the sound-volume-threshold determining means determines that the volume of the surrounding sound exceeds the threshold, the combining/not-combining instructing means may instruct the combining and transferring means to combine the balloon signal and the caption-text signal with the video signal.

Furthermore, the contents playback apparatus may further include moving-speed measuring means which measures a moving speed of the contents playback apparatus. The combining/not-combining instructing means determines whether the moving speed measured by the moving-speed measuring means exceeds a predetermined threshold and, when the moving speed exceeds the predetermined threshold, instructs the combining and transferring means to combine the balloon signal and the caption-text signal with the video signal.

Also, the combining/not-combining instructing means may instruct, upon an instruction from a user, the combining and transferring means to combine or not to combine the balloon signal and the caption-text signal with the video signal.

Furthermore, upon an instruction from a user, the caption-text-signal generating means may generate normal caption-text signal for displaying the caption text on an inner edge of a screen, based on the balloon data. At this time, when the caption-text-signal generating means may generate the normal caption-text signal, the combining and transferring means combines only the normal caption-text signal and the video signal to generate a combined signal and may transfer the combined signal to the display apparatus.

Preferably, the combining and transferring means combines the balloon signal, the caption-text signal, and the video signal for each frame.

More preferably, the contents playback apparatus may further includes display means which displays video after combining based on a combined signal transferred from the combining and transferring means.

The present invention is also directed to a computer-readable recording medium having recorded thereon data having a structure for causing a computer apparatus to display video contents with balloon captions. The data recorded on the recording medium includes: a structure for storing information about time to display a balloon in video based on the video-contents-data serving as original data; a structure for storing information about an area where the balloon is to be displayed in the video correspondingly to the information about the time; a structure for storing information about a shape of the balloon in the area correspondingly to the information about the time; and a structure for storing information about caption text to be inserted in the balloon correspondingly to the information about the time.

Preferably, the structure for storing the information about the time includes; a structure for storing information indicative of a caption start time; and a structure for storing information indicative of a caption duration.

The present invention is also directed to the data structure as described above for causing a computer apparatus to display video contents with balloon captions.

The present invention is also directed to a contents providing system including: a balloon-data generating apparatus which generates balloon data by using at least one piece of information among information about time to display a balloon in video based on video-contents-data as original data, information about an area where the balloon is to be displayed on the video, information about a shape of the balloon in the area, and information about caption text to be inserted in the balloon; contents providing means which multiplexes the balloon data generated by the balloon-data generating apparatus and the video-contents-data to generate multiplexed data and provides the multiplexed data as video contents; and a contents playback apparatus which plays back the video contents with balloon captions based on the multiplexed data provided by the contents providing means.

The contents providing means may transmit the multiplexed data to the contents playback apparatus through wireless broadcasting, through network distribution, or through a packaged medium.

According to the present invention, in video contents, caption text can be inserted in a balloon for display. With this, the relation between the speaker and the caption is clear to understand. Furthermore, with caption text being displayed in a balloon, the entire screen is easy to view. The balloon has a start point, which represents who is speaking. Therefore, even if audio is muted, the speaker and the caption text can be associated with each other, thereby making it possible to ascertain the video. This is particularly useful at places, such as a quiet place where sound should be prohibited and, conversely, a place where sound from the loudspeaker is difficult to listen to due to large surrounding sound. Also, if the present invention is incorporated in a portable communications terminal, the user can ascertain the video without listening to audio through headphones or the like.

Also, the balloon is provided on a portion in a flat color tone. This can prevent the case where an important portion on the screen is hidden by the balloon. Also, the area where the balloon image is to be displayed can be changed upon an instruction from the user. With this, the important part can be intentionally prevented from being hidden by the balloon. Still further, the shape of the balloon image can be changed. Therefore, an appropriate balloon can be selected in accordance with the speech of the speaker. For example, in order to represent a thought in mind, a cloud-like balloon can be used. Still further, the caption text can be changed so as to be enhanced.

The user is automatically notified when the number of caption letters is large. Therefore, the user can create appropriate caption text.

With MPEG data being used as video-contents-data and data complying with XML being used as balloon data, data affinity can be increased, thereby contributing standardization.

The contents playback apparatus can control an audio output and a caption-text display in accordance with the volume of the surrounding sound. Therefore, an output in accordance with the state of the surroundings can be automatically provided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the entire configuration of a broadcast system for broadcasting video contents with captions using balloons according to an embodiment of the present invention;

FIG. 2 is a block diagram showing a functional structure of a contents generating apparatus 1;

FIG. 3 is an illustration showing an example of a data structure of caption list data;

FIG. 4 is an illustration showing an example of a data structure of balloon data;

FIG. 5 is a block diagram showing a functional structure of a contents transmitting apparatus 2;

FIG. 6 is a block diagram showing a functional structure of a contents playback apparatus 4;

FIG. 7 is a block diagram showing a functional structure of a contents display apparatus 5;

FIG. 8 is a flowchart showing the operation of the contents generating apparatus 1;

FIG. 9A is an illustration showing a display on the contents generating apparatus 1;

FIG. 9B is an illustration showing another display on the contents generating apparatus 1;

FIG. 9C is an illustration showing still another display in the contents generating apparatus 1;

FIG. 9D is an illustration showing still another display in the contents generating apparatus 1;

FIG. 10 is an illustration showing one example of eventually-generated balloon data;

FIG. 11 is a flowchart showing the operation of the content transmitting apparatus 2;

FIG. 12 is a flowchart showing the operation of the contents playback apparatus 4;

FIG. 13A is an illustration showing an example of an image based on a video signal generated by the contents playback apparatus 4;

FIG. 13B is an illustration showing an example of an image based on a balloon signal generated by the contents playback apparatus 4;

FIG. 13C is an illustration showing an example of an image based on a caption-text signal generated by the contents playback apparatus 4;

FIG. 13D is an illustration showing another example of an image based on the caption-text signal generated by the contents playback apparatus 4;

FIG. 14 is an illustration showing the operation of a combining/transferring section 43 of the contents playback apparatus 4;

FIG. 15A is an illustration showing an example of a display on the contents display apparatus 5;

FIG. 15B is an illustration showing another example of the display on the contents display apparatus 5;

FIG. 16 is an illustration showing the entire configuration of a system for providing contents data and balloon data via the Internet; and

FIG. 17 is an illustration showing the entire configuration of a system for distributing a package medium, such as a DVD, having stored therein data multiplexed with contents data and balloon data.

### DESCRIPTION OF THE PREFERRED EMBODIMENT

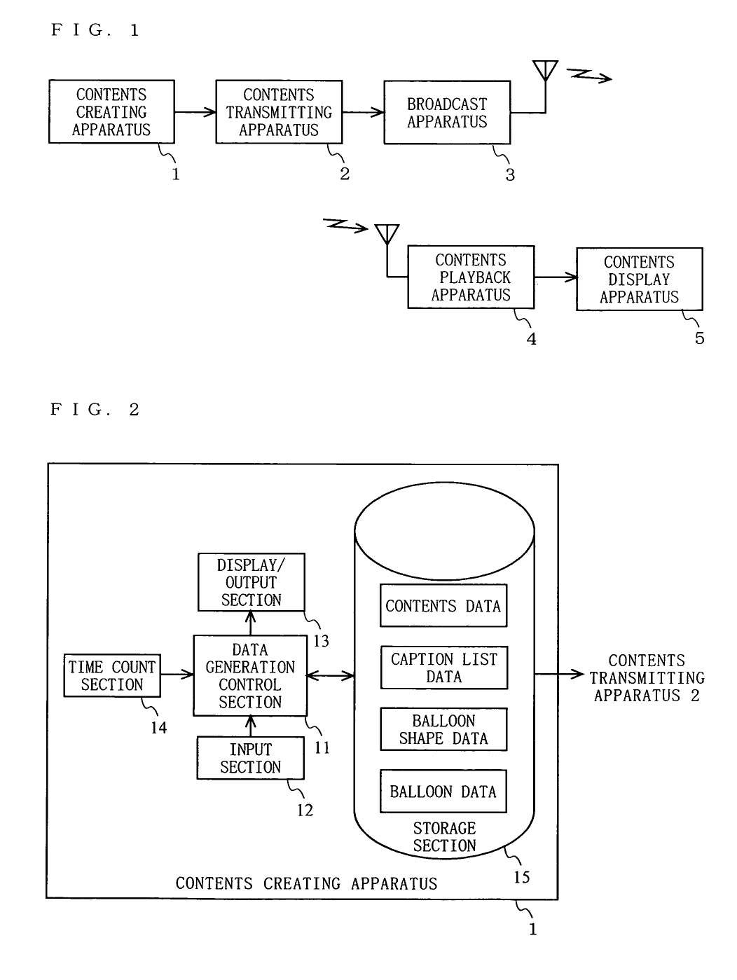

An embodiment of the present invention is described below with reference to the drawings. FIG. 1 is a block diagram showing the entire configuration of a broadcast system for broadcasting video contents with captions using balloons according to an embodiment of the present invention. In FIG. 1, the broadcast system includes a contents generating apparatus 1, a contents transmitting apparatus 2, a broadcast apparatus 3, a contents playback apparatus 4, and a contents display apparatus 5. In FIG. 1, for simplification of description, only one piece of apparatus is shown for each of the contents generating apparatus 1, the contents transmitting apparatus 2, a broadcast apparatus 3, the contents playback apparatus 4, and the contents display apparatus 5. However, two or more pieces of each apparatus may be provided.

The contents generating apparatus 1 generates data (hereinafter referred to as caption-list data) indicating a list of captions corresponding to video based on contents data stored in advance, and balloon data for use in combining the video based on the contents data with video with captions using balloons.

The contents transmitting apparatus 2 obtains the contents data and the balloon data, multiplexes them for transmission as multiplex data to the broadcast apparatus 3 via a local line, a public network, the Internet, an electric wave network, etc. The contents generating apparatus land the contents transmitting apparatus 3 are located at, for example, a contents creator side, such as a contents production company. Here, the multiplex data is transmitted to the broadcast apparatus 3 via the network. Alternatively, the multiplex data may be stored in a recording medium, such as a DVD, to be read by the broadcast apparatus 3.

The broadcast apparatus 3 receives the multiplex data transmitted from the contents transmitting apparatus 2 for broadcast via an antenna. The broadcast apparatus 3 is located at, for example, a broadcasting company, such as a television broadcasting station.

The contents playback apparatus 4 receives the multiplex data transmitted from the broadcast apparatus 3 for analysis, and then causes the contents display apparatus 5 to display video with captions using balloons. The contents display apparatus 4 displays video with captions using balloon in accordance with a signal transmitted from the contents playback apparatus 4. The contents playback apparatus 4 and the contents display apparatus 5 is located, for example, inside a viewer's house.

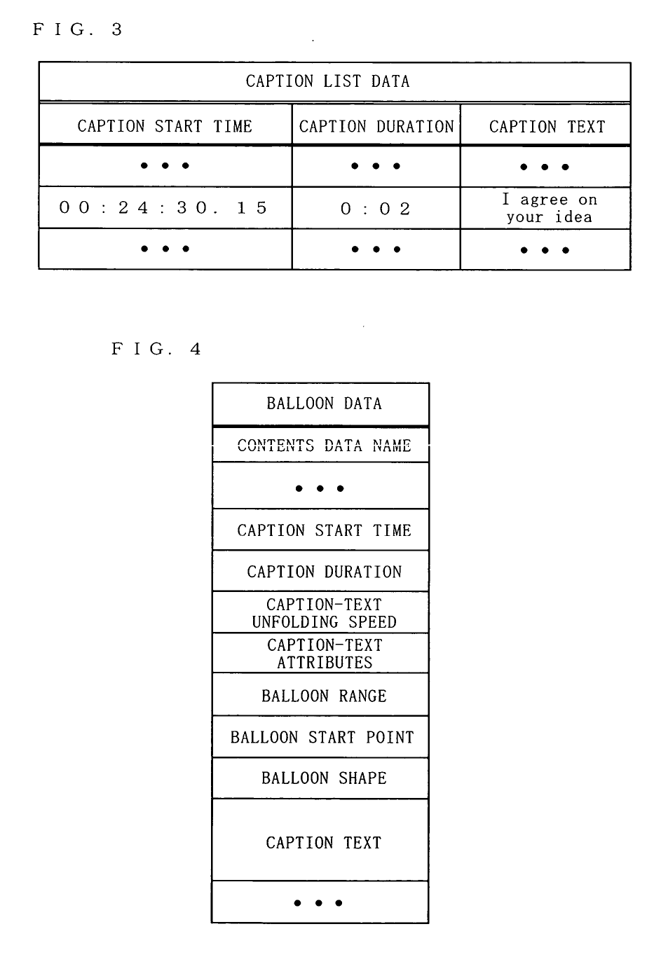

FIG. 2 is a block diagram showing the functional structure of the contents generating apparatus 1. In FIG. 2, the contents generating apparatus 1 includes a data generation control section 11, an input section 12, a display/output section 13, a time count section 14, and a storage section 15.

The input section 12 is an input device, such as a mouse, a keyboard, a touch panel, and a joystick, and is operated for inputting operation information entered by the user to the data generation control section 11.

The storage section 15 is a recording device, such as a hard disk. The storage section 15 has stored therein contents data, caption list data, balloon shape data, and balloon data.

The contents data is encoded stream data of video and audio obtained through an encoding scheme, such as MPEG (Moving Picture Experts Group).

The caption list data has stored therein caption text and information about a time when the caption text is displayed. FIG. 3 is an illustration showing an example of a data structure of the caption list data. As illustrated in FIG. 3, the caption list data has registered therein, for example, caption start time, caption duration, and caption text. Here, the caption start time indicates a time calculated from the start of the contents for starting a display of the corresponding caption text. The caption duration indicates a time period during which the corresponding caption text is continuously displayed. In the example of the caption list data shown in FIG. 3, caption text of “I agree on your idea” is started to be displayed after a fifteenth frame from 24 minutes and 30 seconds after the start of the contents for a duration of 2 minutes. Note that the ordinal frame position is merely an example, and is not meant to be restrictive. Also, the number of frames per second is not meant to be restrictive.

The balloon shape data is data defining the shape of the balloon. For example, in the balloon shape data, a name of the balloon shape and information about the balloon shape are associated with each other.

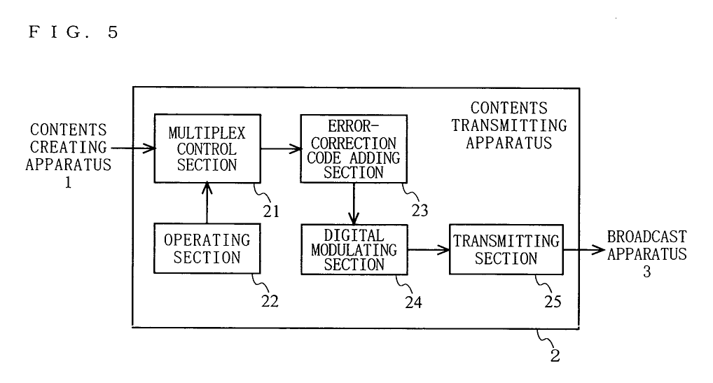

FIG. 4 is an illustration showing an example of a data structure of the balloon data. As shown in FIG. 4, the balloon data has described therein, for example, caption duration, caption-text unfolding speed, caption-text attributes, balloon range, balloon start point, balloon shape, and caption text. These items are described correspondingly to the name of the contents data for each caption start time. The caption start time and the caption duration are information about time to display the balloon. The caption-text unfolding speed, the caption-text attribute, and the caption text are information about the caption text. The balloon range and the balloon start point are information about a balloon area in the video suitable for display of the balloon. The balloon shape is information about a balloon image combined with the balloon area. The balloon data is data generated by using at least one of the following pieces of information in a data format: information about the time to display the balloon, information about the balloon area, information about a balloon image, and information about caption text. For example, the balloon data is described in meta-language. Here, the caption start time, the caption duration, and the caption text are similar to those in the caption list data. The caption-text unfolding speed indicates a speed at which the caption text is sequentially displayed from the head of the caption text within the caption duration. The caption-text attribute indicates a front type, color, background and transmittance, frame type, etc., of the caption text. The balloon range indicates a position on a screen at which the balloon is combined. The balloon start point indicates a position on the screen from which the balloon is started. The balloon shape indicates a name of the balloon registered in the balloon data.

As described above, the balloon data has a structure for allowing a computer apparatus to display video contents with captions using balloons. This structure includes a structure for storing the information about the time to display the balloon (for example, the caption start time and the caption duration described above) on the video based on the video-contents-data serving as original data, a structure for storing the information about the area where the balloon is displayed (for example, the balloon range and the balloon start point described above) on the video in association with the time-related information, a structure for storing the information about the shape of the balloon in the area (for example, the balloon shape described above) in association with the time-related information, and a structure for storing the information about the captions to be inserted in the balloon (for example, the caption-text unfolding speed, the caption-text attributes, and the caption text described above). In the present embodiment, the structure for storing the time-related information includes a structure for storing information indicative of the caption start time and a structure for storing information indicative of a caption duration. The data having such a structure can be stored in a computer-readable recording medium.

The time count section 14 measures time. The display/output section 13 displays an image for generating a video and a balloon and produces audio in accordance with a signal from the data generation control section 11.

The data generation control section 11 plays back the contents data to detect a start time and an end time of audio for obtaining the caption start time and the caption duration. The data generation control section 11 associates the obtained caption start time and caption duration with caption text entered by the user through the input section 12 to generate caption list data, and then stores the caption list data in the storage section 15. The data generation control section 11 refers to the caption list data to detect the audio start time for causing the display/output section 13 to display and output video and audio during a display time. The data generation control section 11 combines the balloon shape with the displayed video, and also combines the caption text in the balloon shape. If the user finally approves the combination results, the data generation control section 11 generates balloon data at the caption start time. The data generation control section 11 then unifies the pieces of balloon data each generated for each caption start time to generate final balloon data. The data generation control section 11 then stores the generated final balloon data in the storage section 15.

FIG. 5 is a block diagram showing a functional structure of the contents transmitting apparatus 2. In FIG. 5, the contents transmitting apparatus 2 includes a multiplex control section 21, an operating section 22, an error-correction-code adding section 23, a digital modulating section 24, and a transmitting section 25.

The operating section 22 is an input device, such as a mouse or a keyboard, for supplying, upon an instruction from the user, information about contents data to be broadcasted to the multiplex control section 21.

The multiplex control section 21 reads, based on the information from the operating section 22, contents data desired by the user and its corresponding balloon data from the storage section 15 of the contents generating apparatus 1, and then multiplexes these two pieces of data. Data obtained through multiplexing is hereinafter refereed to as multiplexed data.

The error-correction-code adding section 23 adds an error-correction-code to the multiplex data obtained through multiplexing by the multiplex control section 21. The digital modulating section 24 digitally modulates the multiplexed data with the error correction code added thereto. The transmitting section 25 transmits the digitally-modulated, multiplexed data to the broadcast apparatus 3. Here, the contents data and the balloon data may be multiplexed by the contents generating apparatus 1 in advance. Also, the function of transmitting the multiplexed data may be included in the contents generating apparatus.

The broadcast apparatus 3 converts the multiplexed data transmitted from the content transmitting apparatus 2 to electric waves for emission. The internal structure of the broadcast apparatus 3 is similar to that of the conventional technology, and therefore is not described in detail herein.

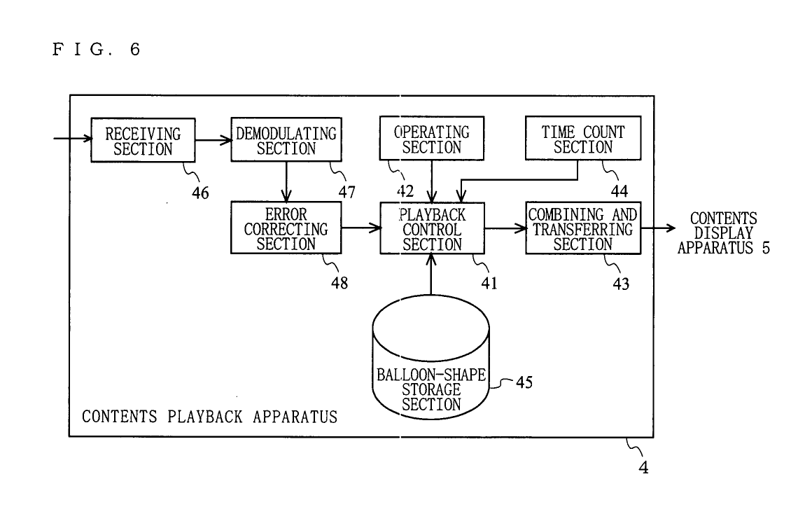

FIG. 6 is a block diagram showing the functional structure of the contents playback apparatus 4. In FIG. 6, the contents playback apparatus 4 includes a playback control section 41, an operating section 42, a combining and transferring section 43, a time count section 44, a balloon-shape storage section 45, a receiving section 46, a demodulating section 47, and an error correcting section 48.

The receiving section 46 receives the electric wave broadcasted from the broadcast apparatus 3. The demodulating section 47 demodulates the electric wave received by the receiving section 46. The error correcting section 48 corrects an error with reference to error correction code included in the multiplex data demodulated by the demodulating section 47.

The operating section 42 is an input device for the user to control the operation of the contents playback apparatus 4. Examples of such an input device are a remote controller and a button switch. The time count section 44 counts time while the contents data is played back. As with the storage section 15 of the contents generating apparatus 1, the balloon-shape storage section 45 has stored therein balloon-shape data.

The playback control section 41 reads contents data from the multiplexed data error-corrected by the error correcting section 48, and then transfers, for each frame, signals regarding video and audio (hereinafter referred to as a video signal and an audio signal) to the combining and transferring section 43. Also, the playback control section 41 reads balloon data from the multiplexed data error-corrected by the error correcting section 48, and then reads data regarding the balloon shape from the balloon-shape storage section 45 based on the information about the balloon shape included in the balloon data. Furthermore, the playback control section 41 generates a signal regarding a balloon image (hereinafter referred to as a balloon signal), and then sends the generated signal to the combining and transferring section 43. Note that, although the same balloon signal may be sent for a plurality of frames, it is assumed herein that the playback control section 41 sends a balloon signal to the combining and transferring section 43 for each frame. The playback control section 41 generates a signal regarding caption text to be inserted in the balloon (hereinafter referred to as a caption-text signal) for each frame, and then sends the caption-text signal to the combining and transferring section 43. Note that the receiving section 46 may be provided outside of the contents playback apparatus 4.

The combining and transferring section 43 combines the signals sent from the playback control section 41 for transfer to the contents display apparatus 5.

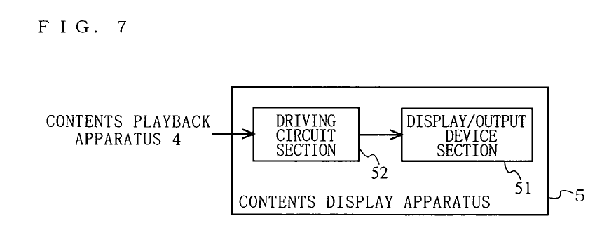

FIG. 7 is a block diagram showing a functional structure of the contents display apparatus 5. In FIG. 7, the contents display apparatus 5 includes a display/output device section 51 and a driving circuit section 52. The display/output device section 51 is implemented by a cathode ray tube, a liquid crystal display, aloud speaker, etc. The driving circuit section 52 causes the display/output device section 51 to playback video and audio based on the combined signal and audio signal transmitted from the contents playback apparatus 4.

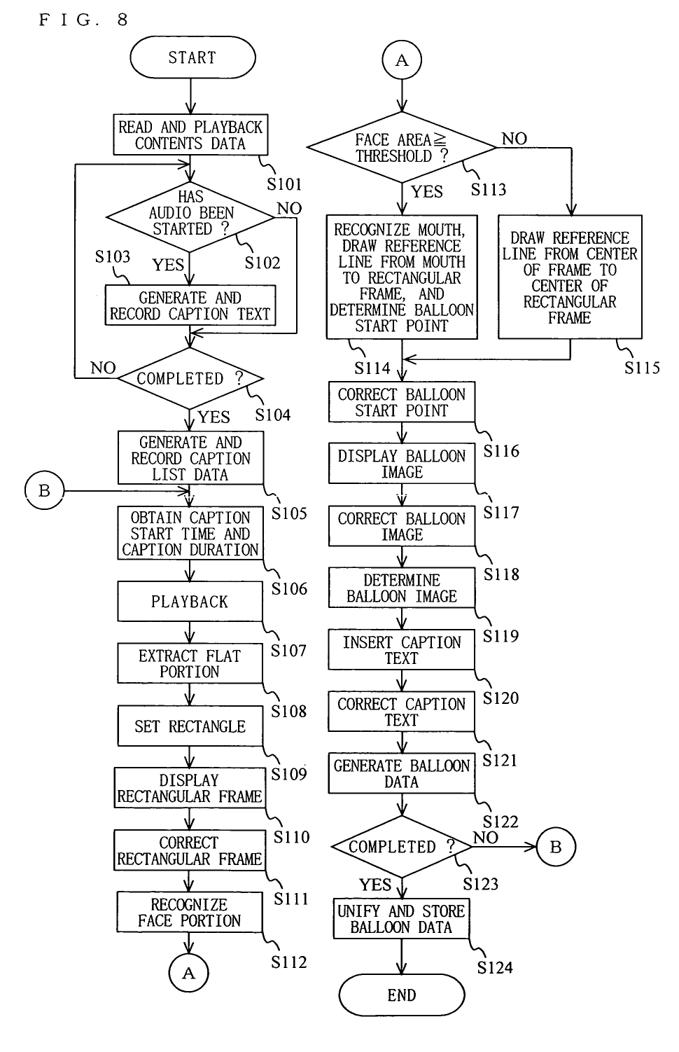

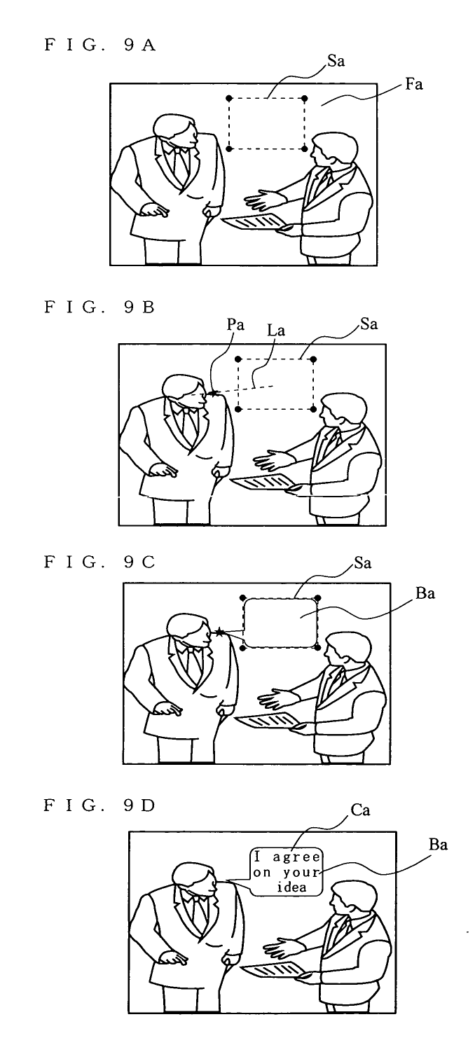

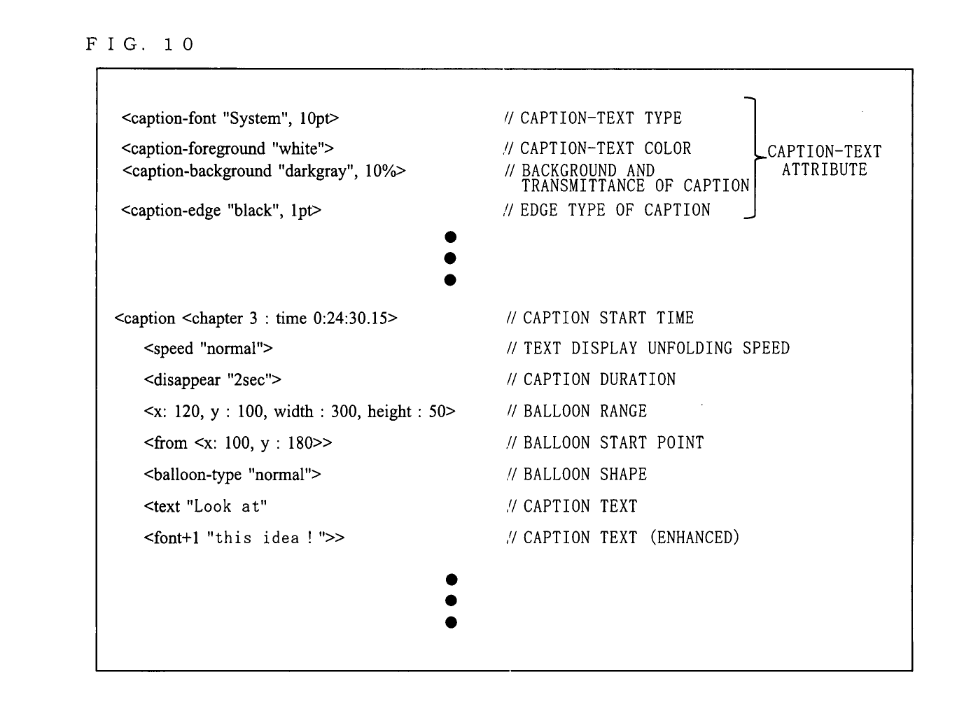

FIG. 8 is a flowchart showing the operation of the contents generating apparatus 1. FIGS. 9A through 9D are illustrations showing examples of a display on the contents generating apparatus 1. With reference to FIGS. 8 and 9A through 9D, the operation of the contents generating apparatus 1 is described below.

First, upon an instruction from the user through the input section 12, the data generating control section 11 of the contents generating apparatus 1 reads desired contents data stored in the storage section 15, and then causes the display/output section 13 to display video and output audio (step S101).

Next, the data generation control section 11 determines through audio recognition whether an audio start time has arrived (step S102). If an audio start time has not arrived, the data generation control section 11 goes to an operation in step S104. On the other hand, if an audio start time has arrived, the data generation control section 11 prompts the user to input caption text corresponding to audio to be produced during a period starting at the audio start time, which is taken as a caption start time, until the audio ends, the period being taken as the caption duration. The data generation control section 11 then stores the caption start time, the caption duration, and the caption text in the storage section 15 as a part of the caption list data (step S103), and then goes to an operation in step S104. At this time, the user preferably leaves a space between caption letters of the caption text.

In step S104, the data generation control section 11 determines whether the playback of the contents data has been completed. If the playback of the contents data has not yet been completed, the procedure returns to the operation in step S102 for generation of caption text at the next audio start time. On the other hand, if the playback of all of the contents data has been completed, the data generation control section 11 collects the pieces of the caption list data generated in step S103 to generate final caption list data for the contents, and then stores the final caption list data in the storage section 15 (step S105). The data generation control section 11 then goes to an operation in step S106.

In step S106, the data generation control section 11 refers to the caption list data to obtain the caption start time and the caption duration. Next, with reference to the contents data, the data generation control section 11 causes the display/output section 13 to playback the video and audio for the caption duration starting from the caption start time (step S107).

Next, the data generation control section 11 calculates a degree of flatness in color in the video for the caption duration starting from the caption start time to extract a portion in a flat color tone (hereinafter referred to as a flat portion) (step S108). Next, the data generation control section 11 sets a rectangle that can fit in the extracted flat portion (step S109). Next, the data generation control section 11 causes the display/output section 13 to display the set rectangle combined with the video at the caption start time so that the rectangle is represented by a dotted frame (hereinafter referred to as a rectangular frame) (step S110). At this time, the data generation control section 11 causes four corners of the rectangular frame as black circles. FIG. 9A is an illustration showing an example of a screen displayed in step S110. As illustrated in FIG. 9A, a rectangular frame Sa is displayed so as to have a maximum size on a flat portion Fa in a flat color tone. Here, the frame may have a shape other than a rectangle.

Next, the data generation control section 11 causes the display/output section 13 to display an image for inquiring the user of whether the rectangular frame displayed in step S110 is set as an range where the balloon is to be displayed. Upon an instruction for correction from the user, the data generation control section 11 sets another rectangular frame according to the instruction as the range where the balloon is to be displayed (step S111). At this time, the data generation control section 11 temporarily stores the coordinates of the four corners of the rectangular frame in a memory (not shown). Also, for frame correction, the user uses the input section 12. For example, the user first puts a pointer of the mouse on any of the four sides or corners, and then drags the side or corner, thereby correcting the size and/or position of the rectangular frame. Such a scheme is well known in the field of image software, and therefore is not described any further herein.

Next, the data generation control section 11 recognizes a face portion of a person in the video (step S112). For such recognition, various schemes can be taken. For example, the data generation control section 11 can recognize the face portion of the person based on skin color, face shape, etc. Such schemes are well known in the field of image recognition, and therefore is not described any further herein.

Next, the data generation control section 11 finds an area of the recognized face portion to determine whether the area exceeds a predetermined threshold (step S113). If the area exceeds the threshold, the data generation control section 11 detects a mouth portion to cause the display/output section 13 to display a reference line drawn from the mouth to a point of intersection of diagonal lines of the rectangular frame (such a point is hereinafter referred to as a center of the rectangular frame), and also to display a provisional balloon start point on the reference line (step S114). The data generation control section 11 then goes to an operation in step S116.

On the other hand, if the area does not exceed the threshold, the data generation control section 11 recognizes the center portion of the face, and then causes the display/output section 13 to display a reference line drawn from that center portion to the center of the rectangular frame and also to display a provisional balloon start point on the reference line. The data generation control section 11 then goes to an operation in step S116. FIG. 9B is an illustration showing an example in which such a provisional balloon start point is displayed in step S115. As shown in FIG. 9B, a balloon start point Pa is displayed on a reference line La drawn from the center of the face to the center of the rectangular frame Sa. As such, the data generation control section 11 determines a start point of the balloon image in accordance with the size of the face.

In step S116, upon an instruction from the user through the input section 12, the data generation control section 11 corrects the balloon start point, stores the coordinates of the corrected balloon start point in the memory (not shown), and then goes to an operation in step S117. If the user does not issue an instruction for correction, the data generation control section 11 stores the coordinates of the provisional balloon start point.

In step S117, the data generation control section 11 reads the data regarding the balloon shape set in advance as a standard balloon shape, changes, if required, the size of the balloon shape so that the balloon has a maximum size within the rectangular frame determined in step S111, and then causes the display/output section 13 to display a balloon image after the size change within the rectangular frame. FIG. 9C is an illustration showing an example of the balloon image displayed in step S117. As illustrated in FIG. 9C, a balloon image Ba is displayed so as to fit in the rectangular frame Sa.

Next, upon an instruction from the user, the data generation control section 11 corrects the balloon image (step S118). Specifically, the shape, size, orientation, etc., of the balloon are corrected. Such corrections are made, for example, by the user selecting a desired shape from a dialog box presenting possible shapes of the balloon. Also, the size can be corrected by dragging the balloon on display. Other various schemes can be taken for correction.

If the correction by the user has been completed or the user does not issue an instruction for correction, the data generation control section 11 determines a final balloon image (step S119). At this time, the data generation control section 11 temporarily stores a name indicative of the shape of the balloon image in the memory (not shown). Also, if the size of the balloon image in the memory (not shown). Also, if the size of the balloon image has been changed, the data generation control section 11 changes the coordinates of the four corners stored in the memory to those of four corners of a rectangular frame having a minimum size to surround the size-changed balloon as a range the balloon is to be displayed.

Next, the data generation control section 11 reads the caption text at the caption start time from the caption list data, and then inserts them in the determined balloon (step S120). At this time, the data generation control section 11 instructs the display/output section 13 to display the caption text for each frame from the start during the caption duration starting at the caption start time. Also at this time, the data generation control section 11 determines a caption-text unfolding speed. The caption-text unfolding speed is defined by determining how many more letters are newly displayed step wise in one frame. For example, it is defined such that six letters are newly displayed in one frame at normal speed. The data generation control section 11 also temporarily stores the caption-text unfolding speed. FIG. 9D is an illustration showing an example of a display when the caption text is inserted. As illustrated in FIG. 9D, caption text Ca are displayed in the balloon image Ba.

Next, upon an instruction from the user, the data generation control section 11 corrects the caption text (step S121). It is assumed herein that caption-text attributes that can be corrected include a type of caption text, color of caption text, caption background, caption transmittance, a type of an edge of the caption, and enhancement of the caption text. The data generation control section 11 also temporarily stores the caption-text attributes in the memory. Note that the data generation control section 11 may preferably include a sound-volume determining section for determining a sound volume of audio during the playback of the video-contents-data. At this time, the contents generating apparatus 1 may preferably change the caption-text attributes in accordance with the sound volume determined by the sound-volume determining section. For example, with a large sound volume, the content generating apparatus 1 enlarges the caption text or changes its color.

Next, the data generation control section 11 reads the information temporarily stored in the memory to store the caption duration, the caption-text unfolding speed, the caption-text attributes, the balloon range (the coordinates of the four corners of the rectangular frame), the coordinates of the balloon start point, the balloon shape, and the caption text in the storage section 15 (step S122).

Next, the data generation control section 11 determines whether generation of balloon data has been completed for the entire contents (step S123). If not completed, the data generation control section 11 continues generation of balloon data for each caption start time. On the other hand, if completed, the data generation control section 11 unifies the pieces of balloon data that have been generated for every caption start time to generate final balloon data corresponding to the desired contents data, and then stores the final balloon data in the storage section 15 (step S124). The data generation control section 11 then ends the procedure.

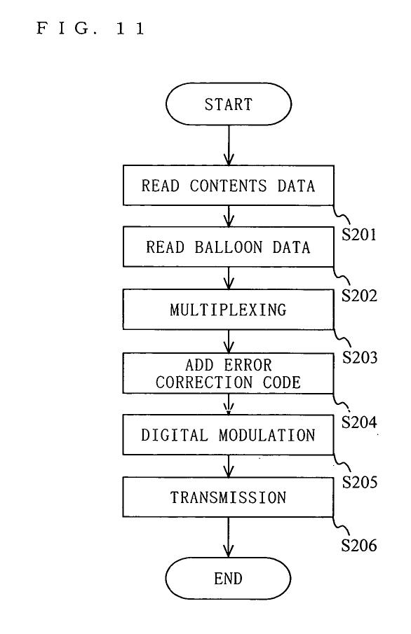

FIG. 10 is an illustration showing an example of the final balloon data. In the example of FIG. 10, in order to provide affinity with an MPEG data format used for the contents data and ease in standardization, the balloon data is described in a format complying with XML (eXtensible Markup Language). As shown in FIG. 10, the balloon data includes a caption-text unfolding speed, a caption duration, a caption range, a caption start point, a balloon shape, and caption text defined for each caption start time. In FIG. 10, the caption-text attributes are applied to the entire contents. Alternatively, the caption-text attributes may be defied for each caption start time.

FIG. 11 is a flowchart showing the operation of the contents transmitting apparatus 2. With reference to FIG. 11, the operation of the contents transmitting apparatus 2 is described below.

First, upon an instruction from the user through the operating section 22, the multiplex control section 21 of the contents transmitting apparatus 2 reads desired contents data stored in the storage section 15 of the contents generating apparatus 1 (step S201). Next, the multiplex control section 21 reads balloon data corresponding to the contents data from the storage section 15 (step S202). Next, the multiplex control section 21 multiplexes the read contents data with balloon data (step S203). Here, an arbitrary multiplexing scheme can be taken. For example, the balloon data is embedded in the header portion of the contents data.

Next, the error-correction-code adding section 23 adds error correction code to the multiplexed data (step S204). Next, the digital modulating section 24 digitally modulates the multiplexed data with the error correction code added thereto (step S205). Next, the transmitting section 25 transmits the digitally-modulated data to the broadcast apparatus 3 (step S206), and then ends the process.

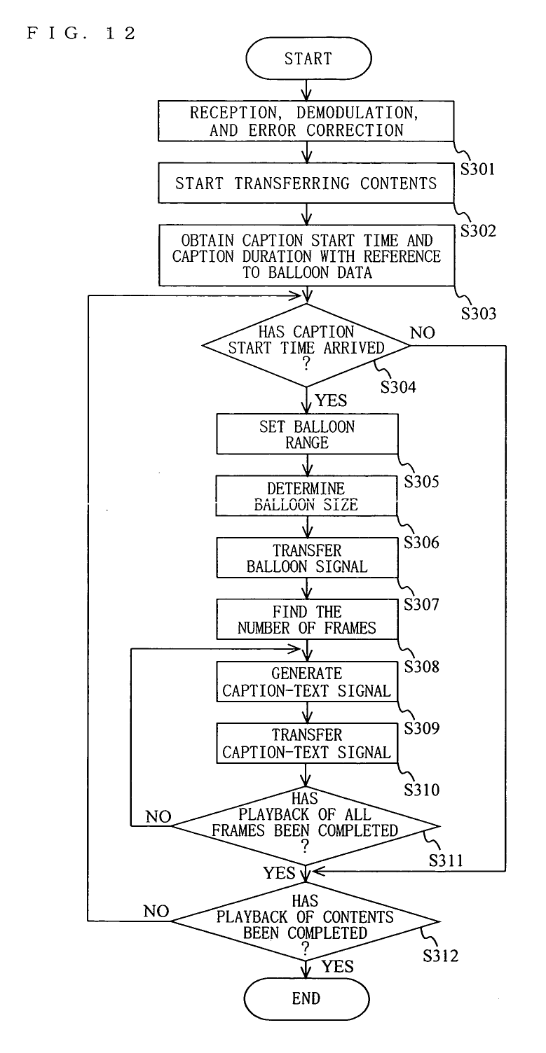

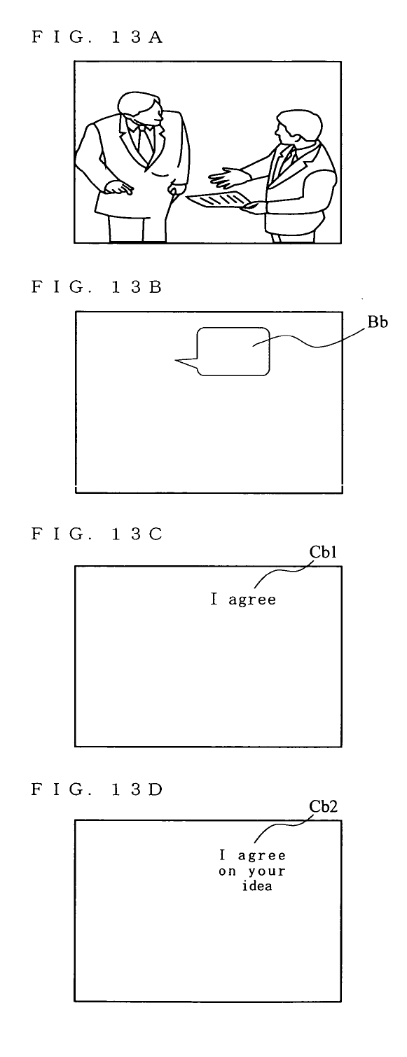

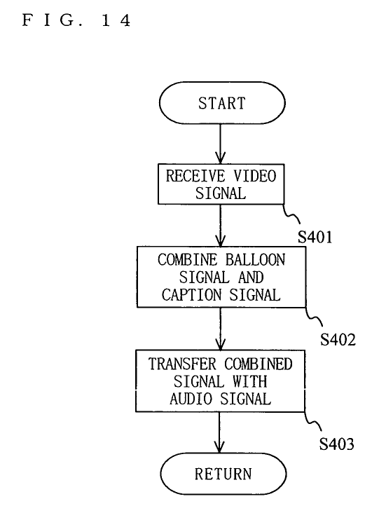

FIG. 12 is a flowchart showing the operation of the contents playback apparatus 4. FIGS. 13A through 13D are illustration showing examples of an image based on a video signal, a balloon signal, and a caption-text signal generated by the contents playback apparatus 4. With reference to FIGS. 12 and 13A through 13D, the operation of the contents playback apparatus 4 is described below.

First, in the contents playback apparatus 4, a signal received at the receiving section 46 is demodulated by the demodulating section 47, is corrected by the error correcting section 48, and is then input to the playback control section 41 (step S301). Next, the playback control section 41 reads contents data from the error-corrected multiplexed data, and then sends a video signal and an audio signal required for playback of the contents data to the combining and transferring section (step S302), concurrently with the following operations in steps S303 through S312. FIG. 13A is an illustration showing an example of an image based on the video signal. As illustrated in FIG. 13A, in step S302, only information regarding the video and audio except the information regarding the balloon is transferred.

Next, the playback control section 41 reads balloon data from the multiplexed data to obtain a caption start time and a caption duration (step S303). Next, based on information from the time count section 44, the playback control section 41 determines whether the caption start time has arrived (step S304). If the caption start time has not arrived, the playback control section 41 goes to an operation in step S312.

On the other hand, if the caption start time has arrived, based on the balloon range included in the balloon data, the playback control section 41 sets a range on a screen where a balloon is inserted (step S305). Next, based on the balloon shape included in the balloon data, the playback control section 41 reads information regarding the designated balloon shape from the balloon-shape storage section 45, and then determines the size of a balloon image so that the balloon fits in the range found in step S305 (step S306). Next, the playback control section 41 generates a balloon signal so that the balloon image having the determined size is displayed in the set range, and then sends the balloon signal to the combining and transferring section 43 (step S307). Here, even though the shape of the balloon is not changed during the caption duration, the playback control section 41 sends the balloon signal for each frame concurrently with the other operations in order to help easy synchronization with the video signal and a caption-text signal. FIG. 13B is an illustration showing an example of an image (balloon image) based on the balloon signal. As shown in FIG. 13B, the balloon signal provides information only about the balloon image.

Next, based on the caption duration stored in the balloon data, the playback control section 41 finds the number of frames in the caption duration (step S308). Next, the playback control section 41 divides the number of caption letters by the number of frames found in step S308 to obtain the number of caption letters to be displayed per frame, generates a caption-text signal for displaying caption text per frame (step S309), and then sends the caption-text signal to the combining and transferring section (step S310). FIG. 13C is an illustration showing an example of an image based on the caption-text signal in the first frame. FIG. 13D is an illustration showing an example of an image based on the caption-text signal in the second frame. As shown in FIGS. 13C and 13D, based on the caption-text signal, the caption text to be displayed during the caption duration gradually appears.

Next, the playback control section 41 determines whether playback of all frames during the caption duration has been completed (step S311). If not completed, the playback control section 41 returns to the operation in step S308 to generate a caption-text signal required for the next frame for transfer to the combining and transferring section 43. If completed, the playback control section 41 determines whether playback of the contents has been completed (step S312). If not completed, the playback control section 41 returns to the operation in step S304 to transfer the balloon signal and a caption-text signal for the next caption start time. If completed, on the other hand, the playback control section 41 ends the procedure.

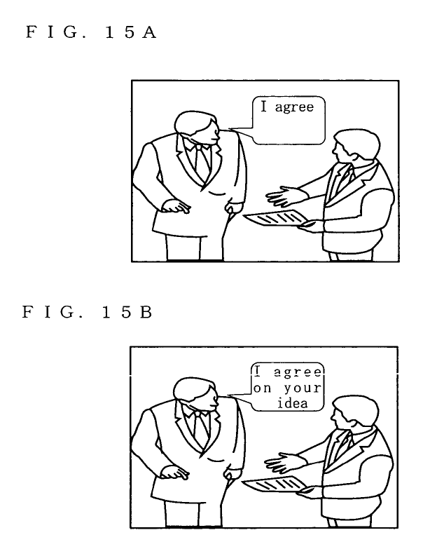

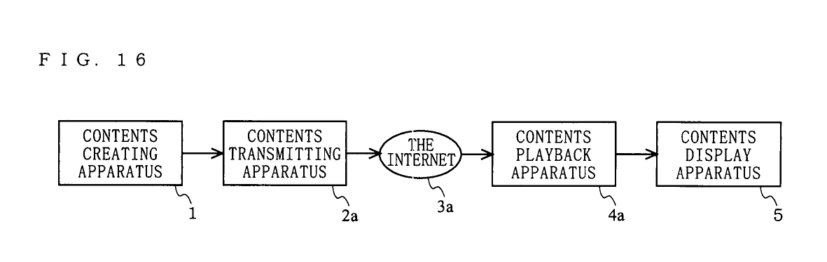

FIG. 14 is an illustration showing the operation of the combining and transferring section 43 of the contents playback apparatus 4. FIGS. 15A and 15B are illustrations showing examples of a display on the contents display apparatus 5. With reference to FIGS. 14, 15A, and 15B, the operation of the combining and transferring section 43 is described below.

First, the combining and transferring section 43 receives the video signal per frame transmitted from the playback control section 41 (step S401). Next, the combining and transferring section 43 receives the balloon signal and the caption-text signal per frame transmitted from the playback control section 41, and then combines the video signal with the balloon signal and the caption-text signal (step S402) for transfer to the contents display apparatus 5 together with the audio signal (step S403). The combining and transferring section 43 then returns to step S401 to go to a process for the next frame.

Upon reception of the signals from the combining and transferring section 43, the contents display apparatus 5 displays a part of the caption in the first frame, as illustrated in FIG. 15A, and then displays the remaining part of the caption in the second frame together with the part of the caption displayed in the first frame, as illustrated in FIG. 15B.

In this manner, according to the embodiment of the present invention, the caption text is inserted in a balloon portion in video contents for display. With this, the relation between the speaker and the caption can be easily understood. Furthermore, with the caption text being displayed in the balloon potion, the screen is easy to view.

In the contents playback apparatus and the contents display apparatus according to the present embodiment, even if audio is muted, who is speaking can be easily understood at a glance by looking at the balloon start point. Therefore, the contents playback apparatus and the contents display apparatus according to the present embodiment can be effectively used to help the user understand the video contents even in an environment where audio has to be muted. With this, the user can enjoy the video contents without using a device such as headphones.

For example, if the contents playback apparatus and the contents display apparatus are set in places where audio should be prohibited, such as libraries, hospitals, a public facilities, the user can enjoy video contents without bothering other people. In this case, the contents playback apparatus and the contents display apparatus can be easily achieved on a personal computer. Furthermore, when the contents playback apparatus and the contents display apparatus are placed as an open-air advertisement apparatus or a public guide service apparatus in an environment where surrounding noise makes it difficult to listening to audio, the user can enjoy video contents by viewing captions using balloons without listening to audio.

In the present embodiment, the contents playback apparatus and the contents display apparatus are separately provided. Alternatively, these apparatuses can be integrated as one apparatus so as to be made small for portable use. With such a portable information terminal, the user can enjoy video contents even in an environment where audio should be minimized as public manners (for example, in side a train, bus, ship, airplane, library, and hospital). As such, the present invention can be effectively used in various ways.

Still alternatively, of the functions of the contents playback apparatus and the contents display apparatus, one of these function may be included in another function. Furthermore, as for the contents generating apparatus and the contents transmitting apparatus, one of their functions may be included in another function.

As described above, for the purpose of more effective use of the present invention in various ways, it is more preferable that the contents playback apparatus (including the one having incorporated therein the contents display apparatus) include functions as described below.

For example, the contents playback apparatus is preferably configured to allow selection as to whether to display balloons upon an instruction from the user. Specifically, when the user issues an instruction for not displaying balloons, the playback control section of the contents playback apparatus instructs the combining and transferring section to combine only the video signal and the audio signal.

Alternatively, the contents playback apparatus may automatically allow selection as to whether to display balloons. For example, the contents playback apparatus may further include a sound-volume measuring section for measuring a volume of the surrounding sound. The contents playback apparatus compares the volume of the sound that is output from the loudspeaker and is measured by the sound-volume measuring section with the volume of the surrounding sound. As a result of comparison, if the volume of the surrounding sound is larger than a predetermined threshold, the playback control section of the contents playback apparatus stops sound outputs from the loudspeaker and instructs the combining and transferring section to switch to a combining process for a balloon-caption display. With this, when the surrounding sound becomes large, the display is automatically switched to a balloon-caption display. Therefore, the user can enjoy video contents even in an environment where sound is less prone to pass.

Still alternatively, when the volume of the surrounding sound is smaller than the predetermined threshold, the playback control section of the contents playback apparatus may automatically perform a process in a manner mode for stopping sound outputs from the loudspeaker and instructing the combining and transferring section to switch a combining process for a balloon-caption display. With this, when the contents playback apparatus is implemented by a mobile terminal such as a cellular phone or a PDA, the mobile terminal automatically enters a manner mode in silent surroundings, and the user can enjoy video contents even in such surroundings.

Still alternatively, the contents playback apparatus may further include a moving-speed measuring section for measuring a speed of the mobile terminal by using an acceleration sensor or in consideration of the Doppler effect of received electric waves. When the moving speed measured by the moving-speed measuring section is faster than a walking speed, the playback control section of the contents playback apparatus may determine that the user is driving or riding in a vehicle, and may instruct the combining and transferring section to switch to a balloon-caption display in a manner mode.

Still alternatively, the contents playback apparatus may switch between a conventional caption display and a balloon-caption display upon an instruction from the user. Specifically, upon an instruction for a conventional caption display from the user, the contents playback apparatus refers to only the caption start time, the caption duration, and the caption-text information to generate a caption-text signal for allowing caption text to be disposed on an inner edge of the screen during the caption duration starting from the caption start time. Then, the combining and transferring section combines the caption-text signal and the video signal for display on the contents display apparatus. With this, a conventional caption display is also possible.

Still alternatively, when generating caption list data, the contents generating apparatus may generate caption list data so as to have registered therein information for enhancing text in accordance with a sound pressure level. Specifically, the contents generating apparatus may include a sound-pressure detecting apparatus for detecting a sound pressure with a piezoelectric sensor or the like. When an average of sound pressures during the caption duration is larger than a threshold, an attribute for enlarging text is registered in the caption list data. When the average is smaller than the threshold, an attribute for reducing text is registered in the caption list data.

Here, when the caption text does not fit in the balloon due to a short caption duration, the contents generating apparatus causes the display/output section to display a mark or the like indicating that the caption text does not fit in the balloon, thereby notifying the user as such. Upon such notification, the user changes the size of the balloon or the caption text. Whether the caption text fits in the balloon is determined by the contents generating apparatus determining whether the number of caption letters per unit time (for example, per frame) during the caption duration is equal to or more than a predetermined number. If the number of caption letters is equal to or more than the predetermined number, the contents generating apparatus determines that the caption does not fit in the balloon, and then notifies the user that the caption text should be changed.

If the number of caption letters are large, a portion of the caption letters fitting in the balloon is first displayed, and then the next remaining portion thereof fitting in the same balloon is newly displayed. Specifically, this can be easily achieved by the contents playback apparatus generating, in step S309, a caption-text signal indicative of the next remaining portion of the caption letters.

The balloon-shape data is ideally standardized. However, if different types of balloon-shape data are used between the contents generating apparatus and the contents playback apparatus, the contents playback apparatus uses, as the balloon-shape data, a standard data predetermined according to a guideline.

In the present embodiment, the contents generating apparatus generates the caption list data and the balloon data separately. Alternatively, the contents generating apparatus may generates the caption list data together with the balloon data. Specifically, the contents generating apparatus may simultaneously register the balloon shape and the caption text upon detection of the start of the audio.

In the present embodiment, the caption list data is generated immediately before the balloon data is generated. Alternatively, the caption list data may be generated in advance separately from the balloon data.

In the present embodiment, the contents generating apparatus first automatically selects a balloon shape, and then the user corrects the shape if necessary. Alternatively, the contents generating apparatus may prohibit the user from making a correction so as to automatically generate balloon data. Still alternatively, the entire balloon data may be manually generated.

In the present embodiment, the contents data and the balloon data are broadcasted. This is not meant to be restrictive a system for providing contents.

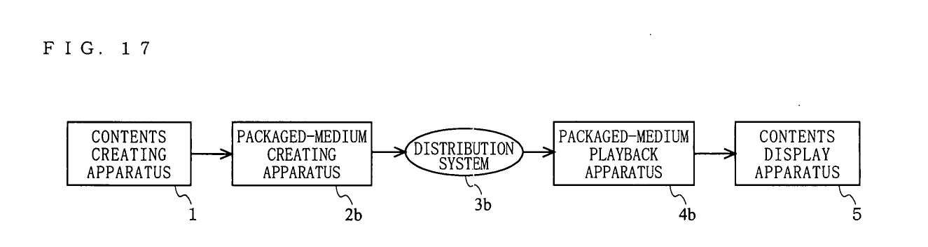

FIG. 16 is an illustration showing the entire configuration of a system for providing contents data and balloon data via the Internet. As illustrated in FIG. 16, a contents transmitting apparatus 2a may transmit, to a contents playback apparatus 4a via the Internet 3a, data obtained by multiplexing contents data and balloon data. In this case, the contents generating apparatus 1 and the contents display apparatus 5 according to the above-described embodiment are utilized. The contents transmitting apparatus 2a performs packet transmission of the multiplexed data via the Internet according to TCP/IP. The contents playback apparatus 4a receives the multiplexed data transmitted via the Internet in units of packets.

FIG. 17 is an illustration showing the entire configuration of a system for distributing data obtained by multiplexing contents data and balloon data and stored in a packaged medium. As illustrated in FIG. 17, a packaged-medium creating apparatus 2b stores the multiplexed data in a recording medium such as a DVD for creating a packaged medium. The packaged medium is delivered to a viewer through a distribution system 3b. A packaged-medium playback apparatus 4b reads the multiplexed data stored in the packaged medium for playing back video contents with balloon captions.

The apparatus for generating video contents with balloon captions, the apparatus for transmitting such video contents, the apparatus for transmitting such video contents, the apparatus for playing back such video contents, and the system for providing such video contents, and the data structure and the recording medium used in these apparatuses allow easy understanding of a relation between a speaker and a caption and also easy viewing of the entire screen, and are useful in a field of contents creation and the like.

While the invention has been described in detail, the foregoing description is in all aspects illustrative and not restrictive. It is understood that numerous other modifications and variations can be devised without departing from the scope of the invention.

1. A contents generating apparatus for generating data required for providing video contents with balloon captions, including:
balloon-display-time extracting means which extracts time to display the balloon in video based on video-contents-data serving as original data;
balloon-area determining means which determines a balloon area suitable for displaying the balloon in video at the time extracted by the balloon-display-time extracting means;
balloon-image determining means which determines a balloon image to be combined with the balloon area determined by the balloon-area determining means;
caption-text determining means which determines caption text to be combined with the balloon image determined by the balloon image determining means; and
balloon-data generating means which generates balloon data by using at least one piece of information among information about the time to display the balloon, information about the balloon area, information about the balloon image, and information about the caption text, wherein
the balloon data generated by the balloon-data generating means is played back together with the video-contents-data, thereby providing the video contents with balloon captions.

2. The contents generating apparatus according to claim 1, wherein
the balloon-area determining means detects a change in color tone in the video based on the video content data, extracts a flat portion in a flat color tone, and takes a frame included in the flat portion as the balloon area, and
the balloon-image determining means takes an image allowing the caption text to be displayed in the frame as the balloon image.

3. The contents generating apparatus according to claim 2, wherein
the balloon-area determining means determines the balloon area by changing the extracted frame based on an instruction from a user.

4. The contents generating apparatus according to claim 2, wherein
the balloon-image determining means changes the shape of the balloon image based on an instruction from a user.

5. The contents generating apparatus according to claim 2, wherein
the caption-text determining means determines the caption text based on an instruction from a user.

6. The contents generating apparatus according to claim 5, wherein
the caption-text determining means determines whether the number of caption letters of the caption text per unit time during the time to display the balloon is equal to or more than a predetermined number, and, when the number of caption letters is equal to or more than the predetermined number, notifies the user that the caption text should be changed.

7. The contents generating apparatus according to claim 2, wherein
the caption-text determining means determines the attribute of the caption text based on an instruction from a user.

8. The contents generating apparatus according to claim 1, further comprising
multiplex means which multiplexes the video-contents-data and the balloon data generated by the balloon-data generating means.

9. The contents generating apparatus according to claim 8, further comprising
multiplexed-data transmitting means which transmits data obtained through multiplexing by the multiplex means through a network.

10. The contents generating apparatus according to claim 8, further comprising
packaged-medium storing means which stores data obtained through multiplexing by the multiplex means in a packaged-medium.

11. The contents generating apparatus according to claim 1, further comprising
sound-volume determining means which determines a volume of sound during playback of the video-contents-data, wherein
the caption-text determining means changes the attribute of the caption text in accordance with the volume of sound determined by the sound-volume determining means.

12. The contents generating apparatus according to claim 1, further comprising
face-size extracting means which extracts a size of a face of a person in video based on the video-contents-data, wherein
the balloon-image determining means determines a start point of the balloon image in accordance with the size of the face extracted by the face-size extracting means.

13. The contents generating apparatus according to claim 1, wherein
the video-contents-data is encoded through MPEG (Moving Picture Experts Group), and
the balloon data is described in XML (extensible Markup Language).

14. A contents transmitting apparatus for transmitting data required for providing video contents with balloon captions, comprising:
balloon-data obtaining means which obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon;
video-contents-data obtaining means which obtains the video-contents-data;
multiplex means which multiplexes the balloon data obtained by the balloon data and the video-contents-data obtained by the video-contents-data obtaining means; and
transmitting means which transmits data obtained through multiplexing by the multiplex means.

15. The contents transmitting apparatus according to claim 14, wherein
the transmitting means transmits the multiplexed data to a broadcast apparatus for wireless broadcasting.

16. The contents transmitting apparatus according to claim 14, wherein
the transmitting means transmits the multiplexed data to a contents playback apparatus for playing back the video-contents-data and the balloon data.

17. A contents-stored packaged-medium generating apparatus for creating a packaged medium having stored therein data required for video contents with balloon captions, comprising:
balloon-data obtaining means which obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon;
video-contents-data obtaining means which obtains the video-contents-data;
multiplex means which multiplexes the balloon data obtained by the balloon data and the video-contents-data obtained by the video-contents-data obtaining means; and
storing means for storing data obtained through multiplexing by the multiplex means in a packaged medium.

18. A contents playback apparatus for playing back video contents with balloon captions, comprising:
balloon-data obtaining means which obtains balloon data generated by using at least one piece of information among information about time to display a balloon in video based on video-contents-data serving as original data, information about an area where the balloon is to be displayed on the video, information about a shape of the balloon in the area, and information about caption text to be inserted in the balloon;
video-contents-data obtaining means which obtains the video-contents-data;
balloon-signal generating means which generates a signal regarding a balloon image based on the balloon data;
caption-text signal generating means which generates a signal regarding the caption text based on the balloon data;
video-signal generating means which generates a signal regarding video based on the video-contents-data; and
combining and transferring means which combines the balloon signal generated by the balloon-signal generating means, the caption-text signal generated by the caption-text signal generating means, and the video signal generated by the video-signal generating means to generate a combined signal, and then transfers the combined signal to a display device.

19. The contents playback apparatus according to claim 18, further comprising
combining/not-combining instructing means which instructs the combining and transferring means to combine or not to combine the balloon signal and the caption-text signal with the video signal, wherein
upon reception of an instruction from the combining/not-combining instruction means for combining the balloon signal and the caption-text signal with the video signal, the combining and transferring means transfers the combined signal to the display apparatus, and upon reception of an instruction for not combining the balloon signal, the caption-text signal, and the video signal, the combining and transferring means transfers only the video signal to the display apparatus.

20. The contents playback apparatus according to claim 18, further comprising:
sound-volume measuring means which measures a volume of surrounding sound; and
sound-volume-threshold determining means which determines whether the volume of the surrounding sound measured by the sound-volume measuring means exceeds a threshold, wherein
the combining/not-combining instructing means instructs the combining and transferring means to combine or not to combine the balloon signal and the caption-text signal with the video signal based on the determination results of the sound-volume-threshold determining means.

21. The contents playback apparatus according to claim 20, wherein
when the sound-volume-threshold determining means determines that the volume of the surrounding sound does not exceed the threshold, the combining/not-combining instructing means instructs the combining and transferring means to combine the balloon signal and the caption-text signal with the video signal, and further prevents an audio output apparatus for outputting audio from outputting audio.

22. The contents playback apparatus according to claim 20, wherein
when the sound-volume-threshold determining means determines that the volume of the surrounding sound exceeds the threshold, the combining/not-combining instructing means instructs the combining and transferring means to combine the balloon signal and the caption-text signal with the video signal.

23. The contents playback apparatus according to claim 18, further comprising
moving-speed measuring means which measures a moving speed of the contents playback apparatus, wherein
the combining/not-combining instructing means determines whether the moving speed measured by the moving-speed measuring means exceeds a predetermined threshold and, when the moving speed exceeds the predetermined threshold, instructs the combining and transferring means to combine the balloon signal and the caption-text signal with the video signal.

24. The contents playback apparatus according to claim 19, wherein
the combining/not-combining instructing means instructs, upon an instruction from a user, the combining and transferring means to combine or not to combine the balloon signal and the caption-text signal with the video signal.

25. The contents playback apparatus according to claim 18, wherein
upon an instruction from a user, the caption-text-signal generating means generates normal caption-text signal for displaying the caption text on an inner edge of a screen, based on the balloon data, and
when the caption-text-signal generating means generates the normal caption-text signal, the combining and transferring means combines only the normal caption-text signal and the video signal to generate a combined signal and transfers the combined signal to the display apparatus.

26. The contents playback apparatus according to claim 18, wherein
the combining and transferring means combines the balloon signal, the caption-text signal, and the video signal for each frame.

27. The contents playback apparatus according to claim 18, further comprising
display means which displays video after combining based on a combined signal transferred from the combining and transferring means.

28. A computer-readable recording medium having recorded thereon data having a structure for causing a computer apparatus to display video contents with balloon captions, the data comprising:
a structure for storing information about time to display a balloon in video based on the video-contents-data serving as original data;
a structure for storing information about an area where the balloon is to be displayed in the video correspondingly to the information about the time;
a structure for storing information about a shape of the balloon in the area correspondingly to the information about the time; and
a structure for storing information about caption text to be inserted in the balloon correspondingly to the information about the time.

29. The computer-readable recording medium according to claim 28, wherein
the structure for storing the information about the time includes:
a structure for storing information indicative of a caption start time; and
a structure for storing information indicative of a caption duration.

30. A data structure for causing a computer apparatus to display video contents with balloon captions, the data structure comprising:
a structure for storing information about time to display a balloon in video based on the video-contents-data serving as original data;
a structure for storing information about an area where the balloon is to be displayed in the video correspondingly to the information about the time;
a structure for storing information about a shape of the balloon in the area correspondingly to the information about the time; and
a structure for storing information about caption text to be inserted in the balloon correspondingly to the information about the time.

31. A contents providing system comprising:
a balloon-data generating apparatus which generates balloon data by using at least one piece of information among information about time to display a balloon in video based on video-contents-data as original data, information about an area where the balloon is to be displayed on the video, information about a shape of the balloon in the area, and information about caption text to be inserted in the balloon;
contents providing means which multiplexes the balloon data generated by the balloon-data generating apparatus and the video-contents-data to generate multiplexed data and provides the multiplexed data as video contents; and
a contents playback apparatus which plays back the video contents with balloon captions based on the multiplexed data provided by the contents providing means.

32. The contents providing system according to claim 31, wherein
the contents providing means transmits the multiplexed data to the contents playback apparatus through wireless broadcasting.

33. The contents providing system according to claim 31, wherein
the contents providing means transmits the multiplexed data to the contents playback apparatus through network distribution.

34. The contents providing system according to claim 31, wherein
the contents providing means transmits the multiplexed data to the contents playback apparatus through a packaged medium.
